(19) United States
(12) Patent Application Publication
(10) Pub. No.: US 2010/0306592 A1
(43) Pub. Date: Dec. 2, 2010

(54) COMPUTER SYSTEM ON AND OFF TEST APPARATUS AND METHOD

(75) Inventor: Ting-Chung Wang, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/497,711

(22) Filed: Jul. 6, 2009

(30) Foreign Application Priority Data
May 31, 2009 (CN) 200910302780.4

(51) Int. Cl. G06F 11/00; G06F 11/273

(52) U.S. Cl. 714/36; 714/E11.02; 714/E11.17

(57) ABSTRACT

A computer system on/off test apparatus includes a time control unit receiving a time interval value and a repetition value, a detecting unit detecting signal parameters of the computer system, and a test control unit receiving an external power supply and switching the power connection between the external power supply and the computer system. The test control unit saves a number of acceptable ranges. The test control unit receives a power-on status signal returned from the computer system in response to the computer system is powered. The test control unit determines whether the power-on status signal is correct and the detected signal parameters of the computer system are within the acceptable ranges correspondingly. The test control unit turns off the computer system after the interval time, and then turns on the computer system to repeat the above process until the test number of tests reaches the repetition value.

### BACKGROUND

1. Technical Field

The present disclosure relates to test apparatuses and methods and, particularly, to a computer system on/off test apparatus and method.

2. Description of Related Art

Because operation speeds of computers continue to accelerate, the stability of motherboards of the computers is becoming increasingly important. To ensure stability of the motherboards, the motherboards must pass a series of standard tests. On/off tests, reset tests, and suspend-wake up tests are major tests applied on a computer motherboard before packing. Testing is executed by manually actuating the power and reset switches. However, manual operation not only limits the number of repetitions, but is also inefficient and inaccurate.

### BRIEF DESCRIPTION OF THE DRAWINGS

FIG. 1 is a block view of an exemplary embodiment of a computer system on/off test apparatus.

FIG. 2 is a flowchart of an exemplary embodiment of a computer system on/off test method.

### DETAILED DESCRIPTION

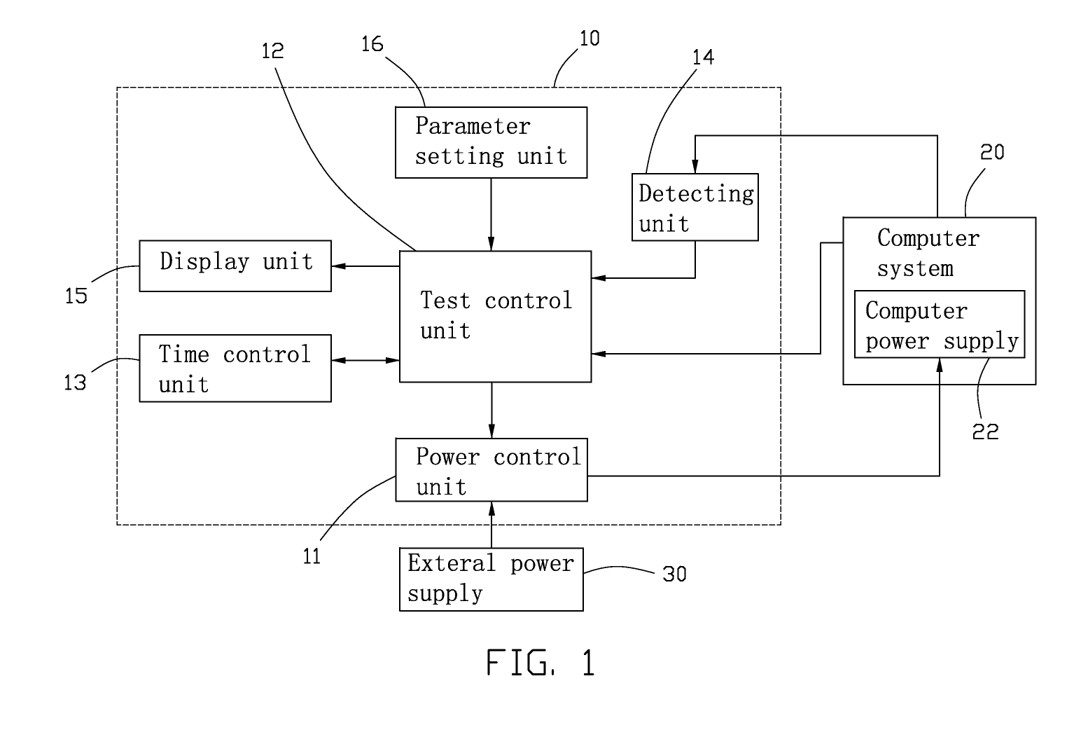

Referring to FIG. 1, an exemplary embodiment of a computer system on/off test apparatus 10 is used to execute an on/off test for a computer system 20. The computer system on/off test apparatus 10 includes a power control unit 11, a test control unit 12, a time control unit 13, a detecting unit 14, a display unit 15, and a parameter setting unit 16. The test control unit 12 is connected to the power control unit 11, the time control unit 13, the detecting unit 14, the display unit 15, and the parameter setting unit 16.

The power control unit 11 is to receive power from an external power supply 30 (such as 110 V alternating current power). The power control unit 11 is also to receive a power-on signal from the test control unit 12 to supply the external power supply 30 to a computer power supply 22 of the computer system 20. The power control unit 11 is able to establish a power connection from the external power supply 30 to the computer power supply 22 of the computer system 20. The power connection is established in response to the power control unit 11 receives a power-on signal from the test control unit 12. The power connection is discontinued in response to the power control unit 11 receives a power-off signal from the test control unit 12. In other embodiments, the power control unit 11 can be omitted, and the test control unit 12 receives power from the external power supply 30 and selectively establishes or discontinues the power connection between the external power supply 30 and the computer power supply 22 of the computer system 20.

The time control unit 13 is to receive a time interval value and a repetition value. The test control unit 12 switches the power connection between the external power supply 30 and the computer power supply 22 of the computer system 20 according to the time interval value and the repetition value. For example, if the time interval value is 0.5 s and the repetition value is 1000, the test control unit 12 repeatedly changes the state of the power connection every 0.5 s, 1000 times (name total test time is 1000). The time interval value and the repetition value can be update/record according to requirements.

The detecting unit 14 is to detect signal parameters of the computer system 20 when the computer system 20 is powered by the external power supply 30, and then output detected signal parameters to the test control unit 12. In one embodiment, the signal parameters include power signals (which may include voltage signals, current signals, power status signals) of the computer power supply 22 of the computer system 20, power signals of a voltage regulator module (VRM) of the computer system 20, port signals of a port 80 of a basic input output system (BIOS) of the computer system 20, power status signals of some important chips (such as a north chip) of the computer system 20, and surface temperature signals of some important chips (such as a central processing unit) of the computer system 20. In other embodiments, the signal parameters of the computer system 20 can be changed according to requirements.

The test control unit 12 is also to save a plurality of acceptable ranges corresponding to the detected signal parameters of the computer system 20. The test control unit 12 is to determine whether the detected signal parameters of the computer system 20 are within the acceptable ranges correspondingly. In detail, when the test control unit 12 sends the power-on signal to the power control unit 11, the computer system 20 is powered. The test control unit 12 receives a power-on status signal returned from the computer system 20. If the power-on status signal is correct and the detected signal parameters of the computer system 20 are within the acceptable ranges, the computer system 20 is passing the on/off test at this time. If the power-on status signal is not correct and the detected signal parameters of the computer system 20 are not within the acceptable ranges, the computer system 20 fails the on/off test, and then the test control unit 12 displays the detected signal parameters and a comparing result with the acceptable ranges via the display unit 15. When this time on/off test is passed, the test control unit 12 changes the power connection state after 0.5s. The signals are evaluated again, and the procedure is repeated again until the test time reach 1000 times.

The parameter setting unit 16 is to update/record the time interval value and the repetition value in the time control unit 13. The parameter setting unit 16 may be a keyboard or other input/output devices.

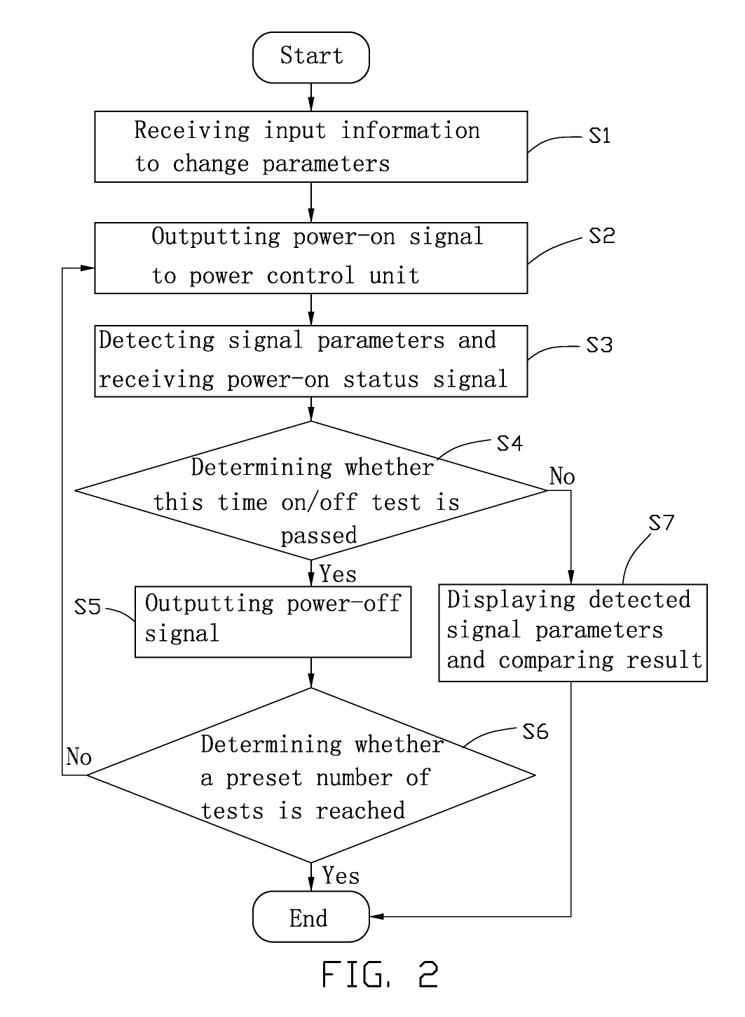

Referring to FIG. 2, an exemplary embodiment of a computer system on/off test method used in the computer system on/off test apparatus 10 includes the following steps.

In step S1, the parameter setting unit 16 receives input information from operators to update/record the time interval value and the repetition value in the time control unit 13.

In step S2, the test control unit 12 outputs the power-on signal to the power control unit 11, to power on the computer system 20.

In step S3, the detecting unit 14 detects signal parameters of the computer system 20, and the test control unit 12 receives the power-on status signal returned from the computer system 20.

In step S4, the test control unit 12 determines whether the power-on status signal is correct and the detected signal parameters of the computer system 20 are within the acceptable ranges correspondingly, namely whether this time on/off test is passed. If this time on/off test is passed, the procedure goes to step S5. If the time on/off test is not passed, the procedure goes to step S7.

In step S5, the test control unit 12 outputs the power-off signal to the power control unit 11 after the time interval value, to turn off the computer system 20. The procedure goes to step S6.

In step S6, the test control unit 12 determines whether the number of tests of the on/off test performed is equal to the repetition value. If the number of the on/off tests is equal to the repetition value, the procedure ends. If the number of the on/off tests is not reach the repetition value, the procedure goes back to step S2.

In step S7, the test control unit 12 displays the detected signal parameters and a comparing result with the acceptable ranges via the display unit 15.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A computer system on/off test apparatus for testing a computer system, the apparatus comprising:
a time control unit to receive a time interval value and a repetition value;
a detecting unit to detect signal parameters of the computer system; and
a test control unit to receive an external power supply and switch a power connection between the external power supply and the computer system, wherein the test control unit saves a plurality of acceptable ranges corresponding to the detected signal parameters of the computer system, wherein the test control unit receives a power-on status signal returned from the computer system in response to the computer system being powered on, the test control unit determines whether the power-on status signal is correct and the detected signal parameters are within the acceptable ranges correspondingly, the test control unit turns off the computer system after the time interval value, and then turns on the computer system to repeat the above process until the number of tests reaches the repetition value; the test control unit displays the detected signal parameters and a comparing result with the acceptable ranges via a display unit in response to the power-on status signal is not correct and the detected signal parameters of the computer system are not within the acceptable ranges.

2. The computer system on/off test apparatus of claim 1, further comprising a power control unit, wherein the test control unit receives the external power supply via the power control unit.

3. The computer system on/off test apparatus of claim 1, further comprising a parameter setting unit to update/record the time interval value and the repetition value.

4. The computer system on/off test apparatus of claim 3, wherein the parameter setting unit is a keyboard.

5. The computer system on/off test apparatus of claim 1, wherein the signal parameters comprises voltage signals, current signals, and power status signals of a computer power supply of the computer system.

6. A computer system on/off test method for testing a computer system, the comprising:
a. outputting a power-on signal to control an external power supply to supply power to the computer system and to power on the computer system;
b. detecting signal parameters of the computer system, and receiving a power-on status signal returned from the computer system;
c. determining whether the power-on status signal is correct and the detected signal parameters of the computer system are within acceptable ranges correspondingly;
d. outputting a power-off signal to control the external power supply to turn off the computer system after a predetermined time interval value in response to the power-on status signal is correct and the detected signal parameters of the computer system are within the acceptable ranges correspondingly;
e. determining whether the number of the on/off tests is equal to a repetition value, wherein the process ends in response to the test time of the on/off test is equal to the repetition value, the process goes to step a in response to the number of the on/off tests has not reached the repetition value; and
f. displaying the detected signal parameters and a comparing result with the corresponding acceptable ranges in response to the power-on status signal is not correct and the detected signal parameters of the computer system are not within the acceptable ranges correspondingly.

7. The computer system on/off test method of claim 6, further comprising a step g before step a, wherein the step g comprises receiving input information to update/record the time interval value and the repetition value.
